(19) United States
(12) Patent Application Publication
(10) Pub. No.: US 2016/0051977 A1
(43) Pub. Date: Feb. 25, 2016

(54) Innovative Auto cut system for 10B Isotope of Boron enrichment using continuous Ion Exchange Chromatography

(71) Applicant: Secretary, Department of Atomic Energy, Mumbai (IN)

(72) Inventors: Anand Babu C., Coimbatore (IN); Mohanakrishnan G., Kancheepuram (Dt) (IN); Nagaraj R., Kancheepuram (Dt) (IN)

(21) Appl. No.: 14/462,975

(22) Filed: Aug. 19, 2014

(51) Int. Cl. B01J 41/12; C01B 35/12

(52) U.S. Cl. CPC B01J 41/125; C01B 35/12

(57) ABSTRACT

The present invention relates to process of enrichment of Boron isotopes by ion exchange chromatography by “Auto Cut” system using continuous Ion Exchange Chromatography. The process comprises development of borate band in the ion exchange chromatographic column; eluting said band without any regeneration in a manner where said ion exchange chromatographic columns comprises 3-9 chromatographic columns in groups of three columns each and connected in series with silicon tubes; and wherein said eluting agent is provided to first column of each said group of three columns; and wherein said enriched boron isotopes are obtained upto 90%.

### FIELD OF THE INVENTION

The present invention relates to process of enrichment of Boron isotopes by ion exchange chromatography. More particularly the invention relates to enrichment of ¹⁰B isotope of Boron 90% by “Auto Cut” system using continuous Ion Exchange Chromatography.

### BACKGROUND AND PRIOR ART

U.S. Pat. No. 5,443,732: Boron isotope separation using continuous ion exchange chromatography: process and apparatus for the continuous and selective separation of boron-10 isotope from a mixture of boron isotopes using boric acid solution by using a weak base ion exchange resin and water eluant in an annular rotating chromatographic column. This method is a continuous, steady-state, method for separating boron isotopes in aqueous boric acid solutions in which ion exchange column having a sufficient length and width to resolve isotopes of boron, especially the ¹⁰B and ¹¹B isotopes into distinct product fractions is described. Work on almost similar lines is also reported in which an isotope separation apparatus comprising 2 to 20 adsorbent-packed columns forming a continuous developing circuit or passageway. The developing units are connected to at least one common main pipe for supplying an isotope mixture solution, a regenerating agent solution, or an eluent solution.

U.S. Pat. No. 4,302,424: Isotope separation: In this patent, the separation of isotopes such as uranium isotopes, nitrogen isotopes, boron isotopes, etc., is performed by continuously developing the isotope mixture solution passed through the individual adsorbent-packed columns successively in each developing unit. The developing units are connected to common liquid-discharge main pipes. The invention describes the basic method of ion exchange chromatography and has a limitation of getting higher enrichment required for Nuclear reactor application without going for cascading.

U.S. Pat. No. 4,447,303: Method of separating boron isotopes: This invention relates to a method of boron isotope enrichment involving the isotope preferential photolysis of dichloroborane using CO₂ laser radiation. To obtain an effective industrial separating method of ¹⁰B and ¹¹B by adding gas containing oxidative gas as an essential component to gaseous boron tribromide. After selectively exciting or dissociating either ¹⁰BBr₃ or and ¹¹BBr₃ by projecting infrared (IR) laser to gaseous boron tribromide, it is allowed to chemically react with oxidative gas such as oxygen and nitrogen monoxide and solid powder of oxide or oxybromide is removed from gas resulting in separation of ¹⁰B and ¹¹B isotopes. In this method, gaseous BBr₃ is irradiated with IR Laser and made to react with O₂ or nitrogen monoxide. Yields are low and hence, not possible to use for production at large scales.

GB736459: Improvements relating to the concentration of isotopes: In this patent counter current distillation method is used to separate boron isotopes from BF₃-DME complex. A method discloses a process for enrichment boron isotope by counter current distillation method is used to separate boron isotopes from BF₃-DME complex. However the present invention teaches a process for the improved separation in discontinuous ion exchange chromatography for enrichment of the stable isotopes of light elements.

U.S. Pat. No. 3,953,569: Concentration of uranium 235 in mixtures with uranium 238 using ion exchange resins: Separation of uranium isotopes has been patented. In this patent the isotopes are separated in ion exchange column using an eluant.

U.S. Pat. No. 4,088,553: Method for separating boron isotopes: In this patent boron isotopes are separated by laser induced selective excitation and photo dissociation of BCl3. Appropriate chemical scavenger reacts with the dissociation product and then it is separated. A method of boron isotope enrichment involving the isotope preferential photolysis of (2-chloroethenyl) dichloroborane as the feed material with CO₂ laser radiation and using fluencies significantly below those required to dissociate BCl₃ has been reported. Laser-induced selective excitation and photo dissociation of BCl₃ molecules containing a particular boron isotope has been used for the separation of boron isotopes. The photo dissociation products react with an appropriate chemical scavenger and the reaction products may readily be separated from undissociated BCl₃, thus effecting the desired separation of the boron isotopes. As photolysis is involved, in the methods using lasers yields are low and hence are not economical for industrial scales.

U.S. Pat. No. 6,086,837: Method of synthesizing enriched decaborane for use in generating boron: A method is described for synthesizing decaborane wherein at least about 90% of the boron atoms in the decaborane are ¹⁰B isotope using series of chemical reaction steps.

JP 2000237545: Boron isotope separating agent and its production: In this patent a separating agent is used to separate boron isotopes

GB 1273807: Process for the concentration of the stable ¹⁰B and ¹¹B isotopes of boron: The patent deals with Boron isotope by countercurrent exchange using an aqueous phase contain boric acid or a complex of boric acid and organic phase contains boric acid or a complex of boric acid with a complex-forming organic compound. The stable (¹⁰B and ¹¹B) isotopes of boron are separated by countercurrent exchange of boric acid or its complex with tartaric acid and Benzene as the organic solvent. The isotope ¹⁰B is preferably enriched in the organic phase and the isotope ¹¹B in the aqueous phase. All additives are required to be removed prior to final use in nuclear applications. The removal of additives is a difficult step involving many complications.

JP2021925: Method for concentrating boron isotope by moving bed: In this patent boron Isotopes separation is achieved with a process in which resin bed moving in a downward direction contacts with the upward moving boric acid solution. A method is described to efficiently increase the content of ¹⁰B by supplying a fresh ion-exchange resin to the top of an exchange tower to form a downward moving bed, allowing an aqueous solution of boric acid to ascend in the tower. The regenerated ion-exchange resin is taken in a hopper and is continuously discharged from the hopper, and supplied to the top of an exchange tower to form a downward moving bed in the tower. Meanwhile, pure water is supplied to the bottom of the tower from a pure water supply line to form an upward liquid flow in the tower. The resin flowing down in the tower is returned to the hopper as slurry by an ejector. This method involves moving bed ion exchange chromatography which is tedious for large scale production. Also achieving higher enrichments using this method is not possible.

EP0297994: Process for the chromatographic separation, especially of isotopes or ions with the aid of ion exchange resin coatings and suitable resins for the process: The patent deals with chromatographic separation of chemical species by means of a pellicular ion exchange resin coated with ion exchange. A process for chromatographic separation of chemical species by means of an ion exchange resin, capable of separating the isotopes of uranium, boron and nitrogen is reported where an isotope exchange is carried out between an isotope of the element fixed on an ion exchange resin and another isotope of the element present in a liquid phase in contact with the ion exchange resin. According to the invention, pellicular resins consisting of composite particles comprising an inert polymer core and at least one active film coat containing ion exchange groups are employed for this exchange. This process involves materials coated on beads that are used for ion exchange reaction. Ion exchange capacities are likely to be lower and hence, require large quantities of materials and higher enrichments are difficult on industrial scales.

JP63028431: Separation of boron isotope: In this patent isotope separation of boron obtained by selective excitation of boron isotopes by projecting infra red laser to gaseous BBr3 and then reacting chemically with oxygen and the solid powder of oxide obtained is removed.

JP60102925: Concentration of boron isotope: This patent deals with the efficient separation of a boron isotope, by using a chelating anion exchange resin having amino polyol as a function group and limiting the concentration. of a boric acid solution to be flowed to a specific range of 0.2-2.0 mol(M)/l while performing treatment at a specific temp range 40-100 deg. C. Efficient separation of a boron isotope by using a chelating anion exchange resin having amino polyol as a function group by column chromatography wherein a boric acid solution is passed through a tower packed with an anion exchange resin to allow the resin to adsorb boric acid and a boric acid adsorbing zone is subsequently developed by an acid solution is reported. In addition, from the heat resistance aspect, the resin has to be used over an extended period; temperature is preferably in a range of 40-100 deg C. Operating temperatures are higher compared to the method mentioned in the patent where operations are carried out at ambient temperatures.

JP60102947: Anion exchange resin for separating and concentrating boron isotope: In this patent high separation coefficient and high adsorption and desorption rates for boric acid is obtained by using aminopolyol anion exchange resin heated to a specified temperature 60-200 deg. C. in a specified medium in a free amine form.

U.S. Pat. No. 7,976,708 B2: Innovative “Cut and feed” operation for enhancing the performance of ion exchange chromatographic separation: This invention is for production of enriched boric acid by using strong base anion resin in ion exchange chromatographic process. This process can produce enriched boric acid up to 75% enrichment in ¹⁰B in 3 to 9 chromatographic columns of 3 to 6 m height in a single cascade. Enriched boron up to 75% enrichment in ¹⁰B is required for the nuclear reactor applications like FBRs and PWRs. Continuous operation of chromatographic columns for enrichment of boron leads to plateau as the separation factor is also very low (in the range of 1.005 to 1.02). Enrichment in single cascade can not be achieved above certain value. This value may be from 35% ¹⁰B to 45% ¹⁰B. The “Cut and Feed” operation described in this invention breaks the plateau and enrichment up to 75% required for nuclear reactors is achieved. Ion exchange chromatography experiment was conducted for enrichment of boron with borate band length of 16 m. Natural boric acid was used as feed. Borate band has been moved using suitable eluting agent with an optimum band velocities in the range of 5 cm/h to 15 cm/h. After borate band moved for 430 m, an enrichment of about 42.5% ¹⁰B was achieved. When the band was moved further by 72 m, the enrichment marginally increased to 42.9%. This condition is called as reaching the plateau with respect to boron enrichment with time. The new invention of “Cut and Feed” operation was employed at this stage. After the cut and feed operation borate band was further displaced by 72 m which increased the enrichment of ¹⁰B to 52%. There is also quantitative advantage with respect to enrichment of ¹⁰B when the new invention is applied. This cut and feed operation is carried out at different stages to enhance the process efficiency. In the invention of “Cut and Feed” operation time taken to enrich 65% in ¹⁰B is 48 months.

Fundamentals Studies on the Ion—Exchange Separation of Boron Isotopes. Hidetake Kakihana, Masahiro Kotaka, Shohei Satoh, Masao nomura, and Makoto Okamoto Bulletin of the Chemical Society of Japan Volume-50(1), 158-163 (1977): The single-stage separation factors for boron isotopes between an ion-exchange resin and an external solution were determined, using an ion-exchange breakthrough operation. The lighter isotope boron-10 was considerably enriched in the anion-exchange resin phase. The separation factor was very much influenced by the boric acid concentration in the external solution, but not as much influenced by the kind of the anion exchange resin used and operation temperature. The separation factor increased with a decrease in the boric acid concentration of external solution from 1.008 (0.501 mol/l) to 1.016 (0.010 mol/l). The value of the separation factors obtained experimentally was compared with those estimated on the basis of the theory of the two-phase distribution of isotopes.

Boron Isotope Separation by Ion Exchange Chromatography Using Weakly Basic Anion Exchange Resin. Yoichi Sakuma, Masao Aida, Makoto Okamoto, and Hidetake Kakihana, Bulletin of the Chemical Society of Japan Volume-53, Issue: 7 Issue date: July 1980 Publication year: 1980 Pages: 1860-1863: Isotopic plateau displacement chromatography, a useful method for isotope separation is presented. The boric acid band formed in a column of weakly basic anion exchange resin Diaion WA21 can be eluted with pure water. In order to obtain good accumulation of the isotope effect, a series of experiments with different migration length were carried out. The boron-10 enriched part of the boric acid absorbed band was always preceded by the isotopic plateau part, in which the atomic fraction of boron-10 was maintained at its original value. The atomic fraction of boron-10 at the end of the chromatogram increased with migration length, and in the case of 256 m migration, boron-10 was enriched from its original atomic fraction of 19.84 to 91%. Pure water is fed to the first column in order to elute the boric acid band, boron-10 being enriched at the rear end boundary. The effluent from the second column was discarded. The third column was connected to the second column in series when the boric acid band of the first column had been completely transferred to the second column. The first column was again saturated with 0.1 mol dm⁻³ boric acid aqueous solution having natural abundance ratio of boron isotopes. The study conducted in this publication reports on enrichment of boron was studied using weak base anion and water as eluent. In study conducted in this publication, report on enrichment of boron was studied using weak base anion and water as eluent, in which continues loading of natural boric acid solution was carried out. ie increasing inventory and also temperature was maintained at 40° C.

Chromatographic Enrichment of ¹⁰B by Using Weak-Base Anion-Exchange Resin, Masao Aida, Yasuhiko Fujii & Makoto Okamoto, Separation Science and Technology Volume 21, Issue 6 & 7, 1986, Pages 643-654: In order to enrich ¹⁰B isotope, a boron adsorption band was eluted 620 m in a reverse-breakthrough displacement manner. The rear boundary of the adsorption band was kept sharp throughout the elution. From monitoring of the isotope abundance during elution, the lighter isotope ¹⁰B was confirmed to be accumulated in the band end region. The maximum enrichment of ¹⁰B reached 98.43% (¹⁰B atomic fraction) at a migration distance of 620 m. The study conducted in this publication reports on enrichment of boron was studied using weak base anion and water as eluent. However continuous loading of natural boric acid solution is carried out for enrichment of boron isotopes which leads to loss of boric acid.

Separation Science and Technology, Volume 32, Issue 13, 1997, Special Issue: Enrichment of Boron-10 by Inverse-Frontal Chromatography Using Quaternized 4-Vinylpyridine-Divinylbenzene Anion-Exchange Resin DOI: 10.1080/01496399708000759 A. Mardan^{a}; pages 2115-2125 Available online: 16 Aug. 2006. This study by A. Mardan teaches enrichment of ¹⁰B meter band migration of boric acid-mannitol with hydrochloric acid solution was performed by inverse frontal chromatography on a porous, 25% crosslinked, 38% quaternized 4-vinylpyridine-divinylbenzene resin. The maximum enrichment (R_{L}) of ¹⁰B was 94.15%. The overall process parameters, namely slope coefficient (k) and separation coefficient (ε), were found to be 0.1282 cm⁻¹ and 0.02967, respectively. This study uses acid as eluent on strong base anion resin.

Drawbacks Connected with Hitherto Known Processes/Devices of Prior Arts:

A process and apparatus for the continuous and selective separation of ¹⁰B isotope from a mixture of boron isotopes in a boric acid solution by using a weak base ion exchange resin and water as eluant in a continuous annular chromatograph is reported. Work on almost similar lines is also reported in which an isotope separation apparatus comprising 2 to 20 adsorbent-packed columns forming a continuous developing circuit or passageway. The separation or concentration of isotopes such as those of uranium, nitrogen, boron etc., is performed by continuously developing the isotope mixture solution after passing through the individual adsorbent-packed columns successively in each developing unit. These patents describe the basic method of ion exchange chromatography and have a limitation of getting higher enrichment required for Nuclear reactor application without going for cascading.

The method for separation of ¹⁰B and ¹¹B isotopes by projecting infrared (IR) laser to gaseous boron tribromide and adding gas containing oxidative gas as an essential component to gaseous boron tribromide results in low yields due to use of lasers and hence, not possible to use for production at large scales.

The methods of boron isotope enrichment involving the isotope preferential photolysis of (2-chloroethenyl) dichloroborane as the feed material with CO₂ laser radiation and Laser-induced selective excitation and photo dissociation of BCl₃ molecules involves photolysis using lasers. In the methods yields are low and hence are not economical for industrial scales.

Separation of a boron isotope by using a chelating anion exchange resin having amino polyol as a function group by column chromatography wherein a boric acid solution is passed through a tower packed with an anion exchange resin to allow the resin to adsorb boric acid and a boric acid adsorbing zone is subsequently developed by an acid solution is reported. The resin has to be used over an extended period in the temperature range of 40-100° C. From the thermal stability point of view, the operating temperatures are higher compared to the method mentioned in the patent where operations are carried out at ambient temperatures.

All additives are required to be removed prior to final use in nuclear applications after the separation of stable (¹⁰B and ¹¹B) isotopes of boron by countercurrent exchange of boric acid or its complex with tartaric acid and Benzene as the organic solvent. The removal of additives is a difficult step involving many complications.

The method reported for efficiently increasing the content of ¹⁰B by supplying a fresh ion-exchange resin to the top of an exchange tower to form a downward moving bed, allowing an aqueous solution of boric acid to ascend in the tower involves moving bed ion exchange chromatography which is tedious for large scale production. Also achieving higher enrichments using this method is not possible.

The reported process on chromatographic separation of chemical species by means of an ion exchange resin, capable of separating the isotopes of uranium, boron and nitrogen is reported where an isotope exchange is carried out between an isotope of the element fixed on an ion exchange resin and another isotope of the element present in a liquid phase in contact with the ion exchange resin using pellicular resins consisting of composite particles comprising an inert polymer core and at least one active film coat containing ion exchange groups involves materials coated on beads that are used for ion exchange reaction. Ion exchange capacities are likely to be lower and hence, require large quantities of materials and higher enrichments are difficult on industrial scales.

The ion exchange chromatography process used for separation of isotopes of boron takes longer duration when it is operated under total reflux condition. This leads to higher cost of production to achieve the desired enrichment. For most of the applications, the enriched boron with 50-75% in ¹⁰B is sufficient. These enrichments are difficult to achieve by the existing processes without cascading which needs higher capital and operating costs.

In study conducted by Yoichi Sakuma et al., (1980), after 140 days and 216 m migration length, there was an enrichment of only 87% of ¹⁰B and in study conducted by Masao Aida et al., after 113 days and 216 m migration length, 87% of ¹⁰B enrichment. In the said two processes each and every column displacement fresh natural boric acid loading was carried out to achieve their enrichment.

Unlike the prior art, in the present invention boric acid loading was carried out initially only and ambient temperature was maintained through out the experiment in the present invention.

The present inventors have surprisingly found that there is significant increase in the enrichment of ¹⁰B isotope of boron in the band when “Auto Cut” operation is carried out, where said “auto cut” mechanism is helpful in overcoming loss of borate band with respect to enrichment.

### OBJECTS OF THE INVENTION

It is an object of the present invention to overcome the drawbacks of the prior art.

It is another object of the present invention to provide an improved process of ion exchange chromatography for achievement of significant enrichment of ¹⁰B isotope of Boron upto 90%.

### BRIEF DESCRIPTION OF THE ACCOMPANYING DRAWINGS

FIG. 1 illustrates the schematic drawing flow diagram of pilot plant setup using weak base anion resin and water.

FIG. 2 illustrates the comparative enrichment profile between B-10 and B-11 isotope.

FIG. 3 illustrates B-10 enrichment rend in 6 cycles of Auto cut.

### SUMMARY OF THE INVENTION

According to one aspect of present invention, there is provided a process for significant enrichment of boron isotopes in ion exchange chromatography, said process comprises the steps of:
i. subjecting a boric acid feed solution to ion exchange chromatographic columns with an ion exchange resin and an eluting agent;
ii. forming borate band in ion exchange chromatographic columns with an optimum band velocity;
iii. eluting said borate band without any regeneration;
iv. allowing borate band to move to a defined distance; and
v. obtaining enriched boron isotopes;
wherein said ion exchange chromatographic columns comprises 3-9 chromatographic columns in groups of three columns each and connected in series with silicon tubes; and
wherein said eluting agent is provided to first column of each said group of three columns; and
wherein said enriched boron isotopes are obtained upto 90%.

### DETAILED DESCRIPTION OF THE INVENTION

The present invention provides an improved process of ion exchange chromatography for enrichment of Boron. Borate band developed in the ion exchange chromatographic column is the first step in the process and is same in both the old processes (as used in Boron Isotope Separation by Ion Exchange Chromatography Using Weakly Basic Anion Exchange Resin. Yoichi Sakuma, Masao Aida, Makoto Okamoto, and Hidetake Kakihana, Bulletin of the Chemical Society of Japan Volume-53, Issue: 7 Issue date: July 1980 Publication year: 1980 Pages: 1860-1863 and Chromatographic Enrichment of ¹⁰B by Using Weak-Base Anion-Exchange Resin Masao Aida, Yasuhiko Fujii & Makoto Okamoto, Separation Science and Technology Volume 21, Issue 6 & 7, 1986, Pages 643-654) and present processes. The eluted column can be used again without any regeneration in the processes of prior arts and the present process. Water inlet is provided to each column in the prior art processes. But in the present process water inlet is provided to first and fourth column. In the present process columns 1-6 connected in series and elution of boron band is carried out using water. After borate band exhausted in column 1-3 (battery of three columns) water inlet is switched over to column 4-6 (battery of three columns) and now columns 4-3 are in series. The eluted column can be used again without any regeneration in processes of prior arts and the present invention.

It has been found by the inventors of the present invention that there is a significant increase in the enrichment of ¹⁰B isotope of boron in the band when “Auto Cut” operation is carried out. When the band was moved from one column to another column in merry-go-round, band expansion and loss of borate is high and enrichment level is low. The “Auto Cut” has helped in overcoming loss of borate band with respect to enrichment. Also the rate of enrichment is higher by “Auto Cut” operation during each battery of columns connected.

“Auto cut” system/operation as used herein refers to a system displacement configuration which is designed to make use of band expansion and is modified in such a way that loss of boric acid band is made advantageous.

In weak base anion ion exchange resin-water process boric band expansion is unavoidable. The “Auto Cut” operation made use of the band expansion in such a way that the expanded front end of the band is allowed to go out of the system. It may be noted that the front end of the band has boric acid with ¹⁰B enrichment is less than that of natural boric acid which was the feed to the system(¹⁰B content 20%). The average enrichment of ¹⁰B in the boric acid band is increased at the end of each cycle of operation which helps in attaining further higher enrichment easier in subsequent cycles of operation. This way the loss of boric acid during “Auto Cut” operation is advantageous in taking care of the band expansion and also helps in further increasing the enrichment in cyclic operation.

“Merry-go-round” as used herein means when boric band is displaced from one column (say column 1) to another column (say column 2), it is getting exhausted. Displacement agent (eluent) inlet is switched over to column 2. When column 2 getting exhausted the same procedure is repeated.

According to preferred embodiment of the present invention, significant enrichment of ¹⁰B isotope of Boron 90% is achieved by using Ion Exchange Chromatography using a weak base anion resin in ion exchange resin and water as eluent. The process of present invention can produce enriched boric acid up to 90% enrichment in ¹⁰B in 3 to 9 chromatographic columns of 3 to 6 m height in a single cascade. Enriched boron up to 90% enrichment in ¹⁰B is required for the nuclear reactor applications like FBRs (Fast Breeder Reactors) and PWRs (Pressurized Water Reactor). Continuous operation of chromatographic columns for enrichment of 65% boron-10 in single cascade can not be achieved in a month.

“Weak base resins” as used herein are formed by reacting primary or secondary amines or ammonia with the chloromethylated copolymer of styrene Di-vinyl benzene. Dimethylamine is commonly used. The ability of the weak base resins to absorb acids depends on the basicity of the resin and the pK of the acid involved.

The ion exchange resin can be weak base anion resins selected from ammonia (NH₃), and diethylamine ((CH₃CH₂)₂NH).

The expression “cascade” as used herein is described as one class of mass-transfer devices consists of assemblies of individual units, or stages, interconnected so that the materials being processed pass through each stage in turn. The two streams move counter currently through the assembly; in each stage they are brought into contact, and then separated. Such multistage systems are called cascades.

The expression “Single cascade” as used herein means boric acid feed is processed and product is with drawled. If this product is fed to the other processing units, it will be multi cascades.

The present process significantly reduces the equilibration time when compared with 4 years in strong base normal resin and 1 year with fine resin and enrichment up to 90% required for nuclear reactors could be achieved easily.

Boron enriched in ¹⁰B constituent is used in the nuclear reactors. The ¹⁰B constituent in natural mineral resources is about 20%, where as FBRs and PWRs require enriched boron up to 50%-75% in ¹⁰B. The process of ion exchange chromatography is used for separation of stable isotopes of light elements. The process of present invention is used for enriching boron isotope to a desired level. The experimental setup for the ion exchange chromatographic operation consists of six columns (each 4.276 cm i.d., 600 cm height) packed with the weak base anion exchange resin 100-200 mesh size (75-150 μm diameter) and equipped with conductivity and pH meters for the measurement of electric conductivity and pH in the column effluent to monitor the band boundary.

Six columns were divided into two groups. Three columns in each group (Columns 1-3 and 4-6) were connected in series with silicon tubes. Water inlet was provided in column 1 and 4 only. So columns 1-3 and 4-6 act as battery of ion exchange columns. The resin in ion exchange column is loaded with natural borate ions as boric acid. The borate band formed inside the column is displaced by water.

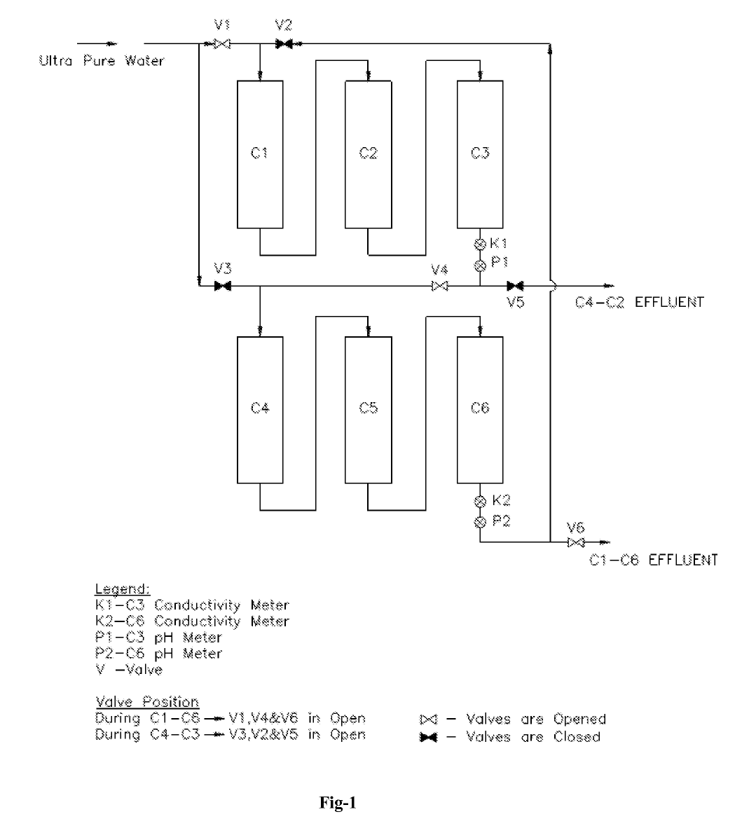

Borate band is moved from one battery of column (C1-C3) to the other battery of ion exchange columns (C4-C6). During C1-C6 displacement, valves V1, V4 and V6 are in opened position and other valves V3, V2 and V5 are in closed position. The Schematic flow diagram is shown in FIG. 1. When boric acid is exhausted in C1-C3 battery water inlet is switched over to C4 by opening the valve V3. The exhausted resin is in OH⁻ form. During C4-C3 displacement, valves V3, V2 and V5 are in opened position and other valves V1, V4 and V6 are in closed position. These operations were continued, thus the ion exchange columns were operated in a merry-go-round fashion.

During the band movement, the rear end of the borate band is enriched in ¹⁰B isotope due to its higher exchange affinity compared to ¹¹B isotope.

The exhausted resin is in hydroxide form need no regeneration process and put back in service to facilitate continuous band movement in front end. The product is eluted out of the band as enriched boric acid solution. The schematic diagram of the set up of the ion exchange chromatographic column is shown in FIG. 1.

Bench scale experiments have shown that slightly higher enrichment than using strong base anion resin and HNO₃ as displacing agents. Based on encouraging results a new pilot scale setup is designed and fabricated to conduct the experiments.

From the experiment results Equilibration time to reach 65% of ¹⁰B is about one month. The present process significantly reduces the equilibration time and overall cost when compared with 4 years in strong base normal resin and 1 year with fine resin.

### Advantages of Present Invention

The process of present invention helps in demonstration of the enrichment of isotopes of boron by ion exchange chromatography in reduced time frame compared with 4 years in strong base normal resin and 1 year with fine resin. It reduces the equilibration time to one month to get 65% of ¹⁰B.

The operation used in the present process is simple, since DM water (demineralised water) is used as the displacing agents. The eluted column can be used again without any regeneration process. The following are the advantages:
1. Easy automation
2. Reduction in consumption of chemicals
3. Avoid handling of acid/alkali and associated corrosion problems.

### DETAILED DESCRIPTION OF THE ACCOMPANYING DRAWINGS

FIG. 1 illustrates the schematic drawing flow diagram of pilot plant setup using weak base anion resin and water.

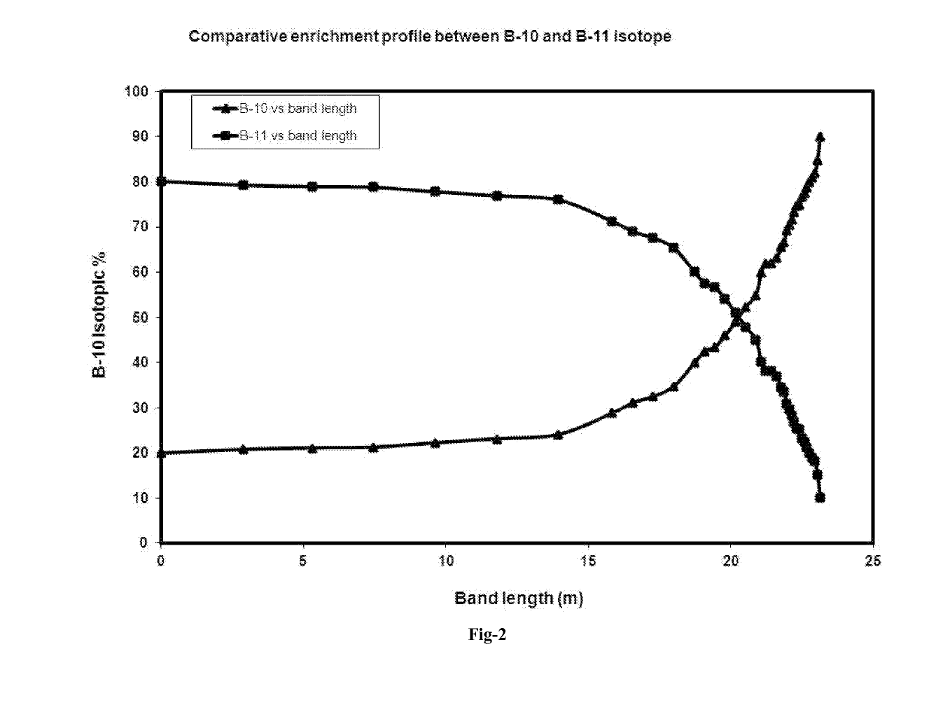

FIG. 2 illustrates the comparative enrichment profile between B-10 and B-11 isotope. After each cyclic operation the ¹⁰B enrichment is increased. FIG. 2 gives the enrichment profile of ¹⁰B after 6 cycles of operation (216 metre migration length) over the complete band length. After 6 cycles of operation ¹⁰B and ¹¹B percentage will be as shown in FIG. 2. Summation of ¹⁰B and ¹¹B is 100 at any position of the borate band.

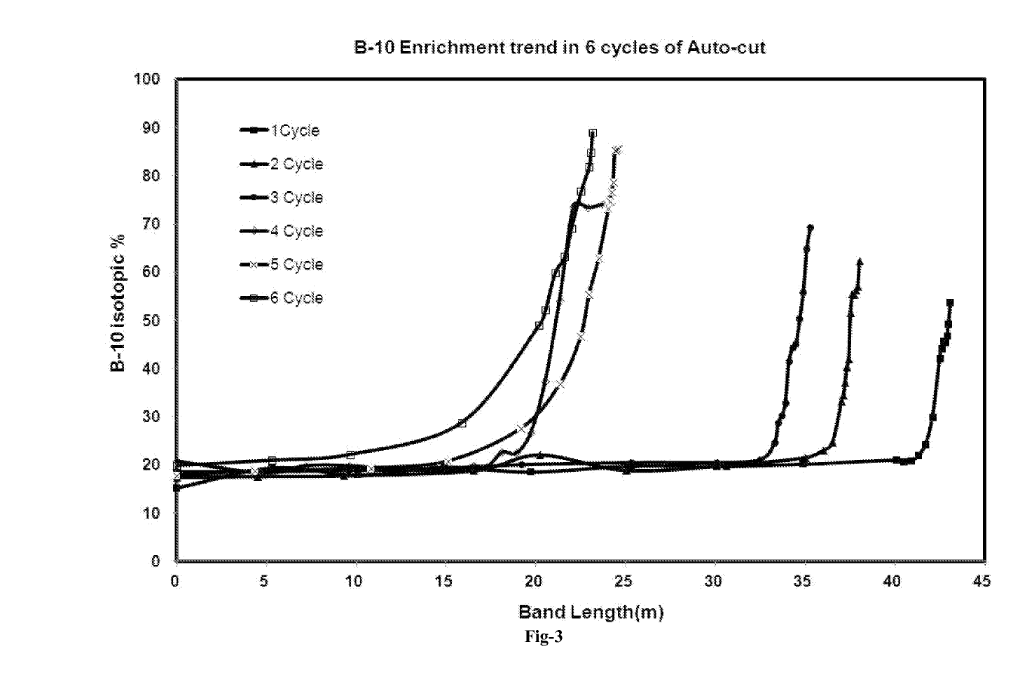

FIG. 3 illustrates B-10 enrichment trend in 6 cycles of Auto cut. One cycle operation is 36 metre migration length. Therefore 1, 2, 3, 4, 5 and 6 cycle of operation is 36, 72, 108, 144, 180 and 216 metre migration length. The band is moved to a band length of 36 m in each cycle of operation. In this figure, the isotopic enrichment profile of ¹⁰B in each cycles of operation is given. Totally 216 m band length is migrated in 6 cycles of operation.

The invention is now described with non-limiting examples as illustrated below:

### Example 1

Ion exchange chromatography experiment was conducted for enrichment of boron with borate band length of 18 m. Natural boric acid was used as feed. Borate band has been moved using water as eluting agent with an optimum band velocity in the range of 5 cm/h to 10 cm/h. Six columns were divided into two groups. Three columns in each group (Columns 1-3 and 4-6) were connected in series. Water inlet was provided in column 1 and 4 only. The “Auto Cut” operation was carried out. After borate band moved for 216 m, an enrichment of about 90% ¹⁰B was achieved and borate band loss rate was minimized with respect to enrichment. There is qualitative advantage with respect to enrichment of ¹⁰B when the new invention is applied. FIG. 2 shows the comparative enrichment profile between B-10 and B-11 isotope

### Example 2

In Boron Enrichment Plant Boron has been enriched using ion exchange chromatography process. In the present process HCl is used as the displacing agent and NaOH as regenerant with strong base anion resins having size of 0.3-1.2 mm. The equilibrium time for attaining 65% enrichment in ¹⁰B was observed to be 48 months. Later a technology was developed using strong base fine resin (75-150 μm particle size) and it reduces the equilibration time to 12 months to get 65% of ¹⁰B. Further to reduce equilibration time and the cost a process has been developed using Weak Base anion resin. The process of present invention uses DM water as eluent and there is no consumption of acid or alkali compared to the other two process mentioned above.

Experiments were conducted in bench scale having 6 numbers of columns in series of 6 m height water is shown in FIG. 1. Columns are packed with the weak base anion TULSION-BCS-IXMP resin (75-150 μm diameter). Three columns were equilibrated with required normality of boric acid solution. The boric acid band was eluted with DM water and the ¹⁰B isotope was found to be enriched at the rear end of the ion exchange column. Displacement with DM water was started and continued in the round the clock. FIG. 3 shows the B-10 enrichment trend in 6 cycles of Auto cut.

We claim:

1. A process for significant enrichment of boron isotopes in ion exchange chromatography, said process comprises the steps of:
i. subjecting a boric acid feed solution to ion exchange chromatographic columns with an ion exchange resin and an eluting agent;
ii. forming borate band in ion exchange chromatographic columns with an optimum band velocity;
iii. eluting said borate band without any regeneration;
iv. allowing borate band to move to a defined distance; and
v. obtaining enriched boron isotopes;
wherein said ion exchange chromatographic columns comprises 3-9 chromatographic columns in groups of three columns each and connected in series with silicon tubes; and
wherein said eluting agent is provided to first column of each said group of three columns; and
wherein said enriched boron isotopes are obtained upto 90%.

2. The process as claimed in claim 1, wherein said boron isotopes is Boron 10.

3. The process as claimed in claim 1, wherein said boric acid solution concentration is about 0.10-0.35M.

4. The process as claimed in claim 1, wherein said ion exchange chromatographic column consists of six columns.

5. The process as claimed in claim 1, wherein said ion exchange resin is weak base anion exchange resin.

6. The process as claimed in claim 5, wherein said weak base anion exchange resin is selected from ammonia (NH₃) and diethylamine ((CH₃CH₂)₂NH).

7. The process as claimed in claim 1, wherein said weak base anion exchange resin is having size of 0.3-1.2 mm.

8. The process as claimed in claim 1, wherein said borate band has a length is 18 m.

9. The process as claimed in claim 1, wherein said borate band distance is 216 m.

10. The process as claimed in claim 1, wherein said borate band is having an optimum band velocity in the range of 5 cm/h to 10 cm/h.

11. The process as claimed in claim 1, wherein said eluting agent is DM water or ultra pure water.

12. The process as claimed in claim 1, wherein said process operates at ambient temperature throughout the process.
